(19) United States
(12) Patent Application Publication
(10) Pub. No.: US 2021/0263376 A1
(43) Pub. Date: Aug. 26, 2021

(54) FLEXIBLE DISPLAY DEVICE

(71) Applicant: InnoLux Corporation, Miao-Li County (TW)

(72) Inventors: Hsin-Hao Huang, Miao-Li County (TW); Tzu-Yi Lin, Miao-Li County (TW); Chu-Hong Lai, Miao-Li County (TW)

(21) Appl. No.: 17/151,651

(22) Filed: Jan. 18, 2021

(30) Foreign Application Priority Data
Feb. 20, 2020 (CN) 202010105205.1

(51) Int. Cl. G02F 1/1335; G02F 1/13357

(52) U.S. Cl. CPC G02F 1/133528; G02F 1/133602; G02F 2202/22; G02F 2202/16; G02F 2202/28

(57) ABSTRACT

A flexible display device having a bending region is provided by the present disclosure. The flexible display device includes a display panel, a first polarizer and a second polarizer disposed under the display panel. The first polarizer is disposed on the display panel and includes a first conductive layer and a first optical layer, wherein the first conductive layer is disposed between the first optical layer and the display panel.

### BACKGROUND OF THE DISCLOSURE

### 1. Field of the Disclosure

The present disclosure relates to a flexible display device, and more particularly to a flexible display device having a design of a polarizer.

### 2. Description of the Prior Art

In liquid crystal display devices, because static electricity may be attracted on the surface of the glass of the display device and affect the action of liquid crystal molecules (for example, change the rotational direction of liquid crystal molecules), defects such as bright spots on the images displayed may occur. Therefore, to improve the electrostatic adsorption on the surface of the glass to avoid affecting the display quality is where to go.

### SUMMARY OF THE DISCLOSURE

A flexible display device is provided by the present disclosure, wherein the flexible display device includes a polarizer having a conductive function. The polarizer having the conductive function of the present disclosure may discharge the static electricity attracted on the glass, thereby improving the display quality of the display device.

According to some embodiments, a flexible display device having a bending region is provided by the present disclosure. The flexible display device includes a display panel, a first polarizer and a second polarizer disposed under the display panel. The first polarizer is disposed on the display panel and includes a first conductive layer and a first optical layer, wherein the first conductive layer is disposed between the first optical layer and the display panel.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a cross-sectional view of an electronic device according to a first embodiment of the present disclosure.

FIG. 2 schematically illustrates a cross-sectional view of a polarizer according to the first embodiment of the present disclosure.

FIG. 3 schematically illustrates a cross-sectional view of an electronic device according to a second embodiment of the present disclosure.

FIG. 4 schematically illustrates a cross-sectional view of a polarizer according to the second embodiment of the present disclosure.

FIG. 5 schematically illustrates a cross-sectional view of an electronic device according to a third embodiment of the present disclosure.

FIG. 6 schematically illustrates a top view of an electronic device according to an embodiment of the present disclosure.

FIG. 7 schematically illustrates a top view of an electronic device according to a fourth embodiment of the present disclosure.

FIG. 8 schematically illustrates a cross-sectional view taken along a line A-A′ shown in FIG. 7.

FIG. 9 schematically illustrates a cross-sectional view taken along a line B-B′ shown in FIG. 7.

FIG. 10 schematically illustrates a top view of an electronic device according to a fifth embodiment of the present disclosure.

FIG. 11 schematically illustrates a cross-sectional view taken along a line C-C′ shown in FIG. 10.

FIG. 12 schematically illustrates a cross-sectional view taken along a line D-D′ shown in FIG. 10.

FIG. 13 schematically illustrates a cross-sectional view of an electronic device according to an embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the electronic device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, electronic equipment manufacturers may refer to an element by different names. This document does not intend to distinguish between elements that differ in name but not function.

In the following description and in the claims, the terms “include” and “comprise” are used in an open-ended fashion, and thus should be interpreted to mean “include, but not limited to . . . ”.

It will be understood that when an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

It should be noted that the technical features in different embodiments described in the following can be replaced, recombined, or mixed with one another to constitute another embodiment without departing from the spirit of the present disclosure.

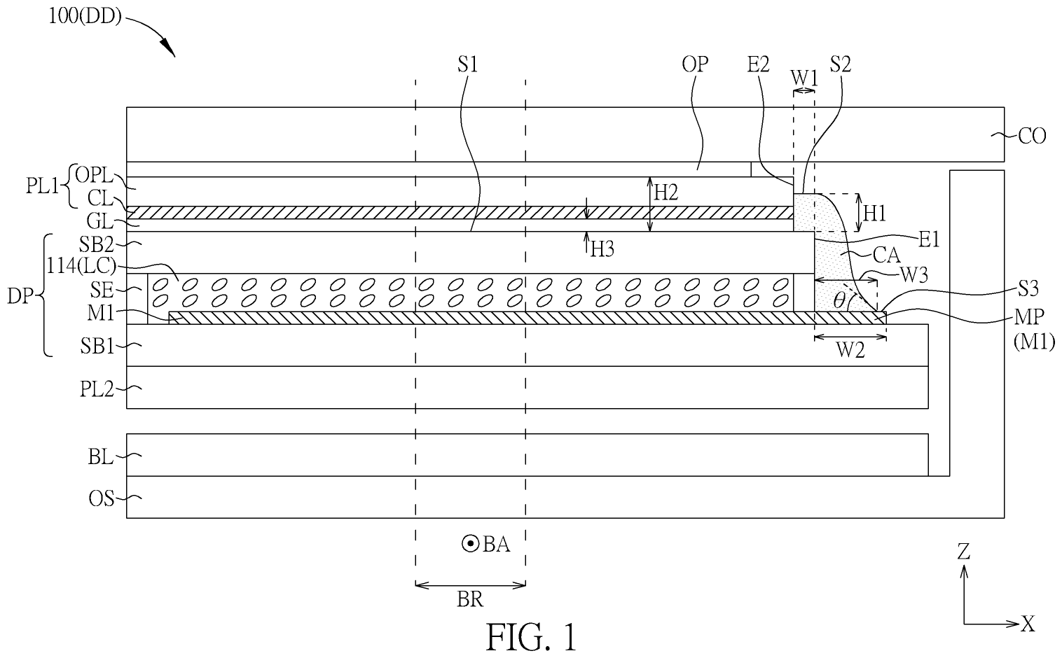

Referring to FIG. 1, FIG. 1 schematically illustrates a cross-sectional view of an electronic device according to a first embodiment of the present disclosure. The electronic device 100 shown in FIG. 1 may for example include laptop, public display, filed display, vehicle display, touch display, television, surveillance camera, smart phone, tablet, light source module, lighting device or the electronic devices applied to the above-mentioned products, but not limited thereto. In some embodiments, the electronic device 100 may include antenna or sensing devices such as liquid crystal antenna, but not limited thereto. In the present embodiment and the following embodiments of the present disclosure, the display device DD is taken as an example of the electronic device 100 for illustration, and will not be redundantly described in the following. According to the present disclosure, the display device DD may for example be a flexible display device and include at least one bending axis BA and at least one bending region BR, wherein the flexible display device may for example be curved, folded, stretched, flexed, rolled or deformed in other ways along at least one bending axis, or it can be said that the portion of the flexible display device located in the bending region BR may be curved, folded, stretched, flexed, rolled or deformed in other ways, but not limited thereto. In some embodiments, the display device DD may be a non-flexible display device. As shown in FIG. 1, the display device DD may for example include a display panel DP, a first polarizer PL1 and a second polarizer PL2 in the present embodiment, but not limited thereto. The display panel DP may for example include a first substrate SB1, a display medium layer LC, a second substrate SB2 and a sealing element SE. In some embodiments, the display device DD may for example be a liquid crystal display device, so the display panel DP may be a liquid crystal display panel, the display medium layer LC may for example include a liquid crystal layer 114, and the liquid crystal layer 114 may for example include liquid crystal molecules, but the present disclosure is not limited thereto. The first substrate SB1 and the second substrate SB2 may be rigid substrates or flexible substrates, and the materials of the first substrate SB1 and the second substrate SB2 may for example include glass, quartz, sapphire, ceramic, plastic, other suitable materials or the combinations of the above-mentioned materials, but not limited thereto. The flexible substrate may for example include plastic substrates such as polyimide (PI) substrate, polycarbonate (PC) substrate or polyethylene terephthalate (PET) substrate, other suitable substrates or the combinations of the above-mentioned substrates, but not limited thereto. The surface of the first substrate SB1 may include a circuit layer Ml, wherein the circuit layer Ml is disposed on the first substrate SB1 and may for example include platinum, aluminum, copper, gold, silver or the combinations of the above-mentioned materials. The circuit layer Ml may include various kinds of wires, electronic elements (such as driving element, conductive element, switch element, capacitor, electrode and the like), circuits and the like, but not limited thereto. Although the circuit layer Ml shown in FIG. 1 is presented by only a single layer, the circuit layer Ml may include a plurality of layers such as conductive layers and insulating layers. The surface of the second substrate SB2 may for example include a light converting layer including any light converting element capable of changing or adjusting the wavelength of lights. For example, the light converting element may include quantum dot, fluorescent material, phosphorescent material, color filter layer, other suitable materials or the combinations of the above-mentioned materials, but not limited thereto. The quantum dot may for example include cadmium selenide (CdSe), cadmium sulfide (CdS), cadmium telluride (CdTe), zinc selenide (ZnSe), zinc telluride (ZnTe), zinc sulfide (ZnS), mercury telluride (HgTe), indium arsenide (InAs), alloy (Cd₁₋ₓZnₓSe_{1-y}S_{y}), cadmium selenide/zinc sulfide (CdSe/ZnS), indium phosphide (InP) and gallium arsenide (GaAs), but not limited thereto. In addition, although it is not shown in FIG. 1, the second substrate SB2 may further include a light shielding material (such as a black matrix (BM)), but not limited thereto. The display medium layer LC is disposed between the second substrate SB2 and the first substrate SB1, and the display medium layer LC may for example include liquid crystal. The sealing element SE is disposed between the second substrate SB2 and the first substrate SB1, and the sealing element SE surrounds the display medium layer LC to bond and fix the first substrate SB1 and the second substrate SB2. In addition, the elements and layers of the display panel DP shown in FIG. 1 are only exemplary, and they do not represent all of the elements or the layers included in the display panel DP. In some embodiments, the display panel DP may further include other suitable elements or layers. As shown in FIG. 1, the direction X may for example be the horizontal direction of the surface of the first substrate Sb1, and the direction Z may for example be the normal direction of the surface of the first substrate SB1, but not limited thereto.

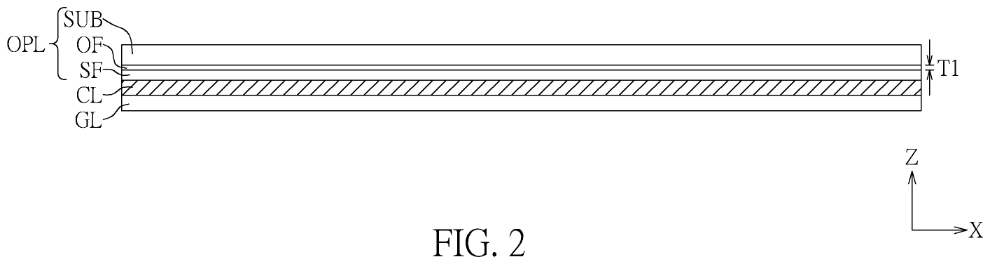

Referring to FIG. 2, as well as FIG. 1, FIG. 2 schematically illustrates a cross-sectional view of a polarizer according to the first embodiment of the present disclosure. As shown in FIG. 1, the display device DD may include a first polarizer PL1 and a second polarizer PL2. In addition, the display device DD may further include a glue GL, wherein the first polarizer PL1 may be adhered to the display panel DP by the glue GL, and the second polarizer PL2 may be disposed under the display panel DP. That is, the display panel DP is disposed between the first polarizer PL1 and the second polarizer PL2, but not limited thereto. According to the present embodiment, as shown in FIG. 2, the first polarizer PL1 may for example include a first optical layer OPL and a first conductive layer CL. The first optical layer OPL may for example include an optical film OF, a compensation film SF and a supporting base SUB. The optical film OF may provide polarizing function, and may for example include polyvinyl alcohol (PVA) or other suitable materials. The compensation film SF may be used to compensate in-plane optical properties, and may for example include any material suitable as the compensation film in the polarizer. The supporting base SUB may be used to provide supporting function of the polarizer, and may for example include triacetate cellulose. It should be noted that although FIG. 2 shows the structure that the optical film OF is disposed between the compensation film SF and the supporting base SUB, the present disclosure is not limited thereto. In some embodiments, the compensation film SF may not be disposed under the optical film OF, that is, the first optical layer OPL may include the optical film OF and the supporting base SUB only, but not limited thereto. According to the present embodiment, the thickness T1 of the optical film OF may range from 20 micrometers (μm) to 40 μm (20 μm≤T1≤40 μm), such as 28 μm, but not limited thereto. The first conductive layer CL may be disposed under the first optical layer OPL. In detail, the first conductive layer CL is disposed between the first optical layer OPL and the glue GL, that is, the first conductive layer CL is disposed between the first optical layer OPL and the display panel DP. According to the present embodiment, the first conductive layer CL may include any suitable transparent conductive material such as indium tin oxide (ITO), indium zinc oxide (IZO), other suitable conductive materials or the combinations of the above-mentioned materials. It should be noted that the structure and material of the second polarizer PL2 may be the same as or different form the structure and the material of the first polarizer PL1 mentioned above. The second polarizer PL2 may be adhered to the surface of the display panel DP away from the first polarizer PL1 by a glue. When the second polarizer PL2 and the first polarizer PL1 are the same, the second polarizer PL2 may also include the optical layer and the conductive layer, and when the second polarizer PL2 is different from the first polarizer PL1, the second polarizer PL2 may for example include the optical layer but not include the conductive layer, but not limited thereto. Other embodiments of the first polarizer will be detailed in the following, and the second polarizers of the following embodiments may optionally have the same structure or different structure as the first polarizer, which will not be redundantly described.

Referring to FIG. 1 again, the display device DD may further include a conductive glue CA in addition to the above-mentioned elements or layers, wherein the conductive glue CA may for example be silver glue, other suitable conductive glue or the combinations of the above-mentioned materials, but not limited thereto. As mentioned above, the circuit layer Ml is disposed on the first substrate SB1 of the display panel DP, and because the length of the first substrate SB1 in the direction X may be greater than the length of the second substrate SB2 in the direction X in the present embodiment, wherein the direction X is substantially parallel to the surface of the first substrate SB1, a portion of the circuit layer Ml disposed on the first substrate SB1 may protrude from the side surface E1 of the second substrate SB2 and the sealing element SE, and the portion of the circuit layer Ml protruding from the side surface E1 of the second substrate SB2 and the sealing element SE may for example include a metal pad MP in the present embodiment, wherein the metal pad MP may for example be connected to the electronic elements (such as common electrode, scan line or signal line) of the circuit layer Ml disposed on the first substrate SB1, but not limited thereto. According to the present embodiment, the conductive glue CA may electrically connect the first conductive layer CL of the first polarizer PL1 and the metal pad MP disposed on the first substrate SB1. For example, the conductive glue CA may be directly in contact with the first conductive layer CL and the metal pad MP, such that the first conductive layer CL can be electrically connected to the metal pad MP, but not limited thereto. In detail, because the length of the second substrate SB2 in the direction X may be greater than the length of the first polarizer PL1 and the length of the glue GL in the direction X, the conductive glue CA may for example be disposed on the second substrate SB2. For example, the horizontal first distance W1 between the side surface E2 of the first polarizer PL1 (or the glue GL) and the side surface E1 of the second substrate SB2 may range from 0 to 0.5 μm (0≤W1≤0.5 μm), but not limited thereto. It should be noted that the above-mentioned first distance W1 may for example be defined as the shortest distance between the side surface E2 and the side surface E1 in the direction X in the present embodiment, but the present disclosure is not limited thereto. When the first distance W1 between the side surface E2 and the side surface E1 is greater than 0, the second substrate SB2 may protrude from the first polarizer PL1, and the conductive glue CA may be disposed on the second substrate SB2 and in contact with the first conductive layer CL; when the distance between the side surface E2 and the side surface E1 is 0, the second substrate SB2 may substantially be aligned with the first conductive layer CL in the direction Z (that is, the side surface E1 is substantially aligned with the side surface E2 in the direction Z), the conductive glue CA may for example disposed along the side surface E1 of the second substrate SB2 and the side surface E2 of the first conductive layer CL, and the conductive glue CA may be in contact with the first conductive layer CL, but not limited thereto. The term “aligned with” mentioned above means that an edge of a layer structure is substantially overlapped with an edge of another layer structure in the direction Z in a cross-sectional view or a side view, and the edges of the two layer structures may be slightly wave-shaped when being observed from the direction Z (top view), which are not straight lines or planes entirely. For example, “the side surface E1 of the second substrate SB2 may be substantially aligned with the side surface E2 of the first conductive layer CL in the direction Z” mentioned above means that the side surface E1 of the second substrate SB2 may substantially be overlapped with the side surface E2 of the first conductive layer CL in the direction Z, and the side surface E1 of the second substrate SB2 and the side surface E2 of the first conductive layer CL may be slightly wave-shaped when being observed from the direction Z (top view), which are not an straight lines or planes entirely, but not limited thereto. According to the present embodiment, because the conductive glue CA may be in contact with the first conductive layer CL, the conductive glue CA may at least have a height that makes it capable of being in contact with the first conductive layer CL. In detail, as shown in FIG. 1, the first polarizer PL1 and the glue GL may have a height H2, the glue GL may have a height H3, and the height of the portion of the conductive glue CA located above the top surface S1 of the second substrate SB2 may be defined as the height H1. That is, the conductive glue CA from the top surface S1 of the second substrate SB2 to the top surface S2 of the conductive glue CA may have the height H1 (or called as a top height). It should be noted that although the top surface S2 of the conductive glue CA shown in FIG. 1 is a flat plane, the present disclosure is not limited thereto. In other embodiments, when the top surface S2 of the conductive glue CA is an uneven surface, the maximum height of the conductive glue CA between the top surface S1 of the second substrate SB2 and the top surface S2 of the conductive glue CA in a cross-sectional view (FIG. 1) may for example be the height H1.

In the present embodiment, the height H1 may be greater than the height H3 and less than or equal to 0.2 times of the height H2 (that is, H3<H1≤0.2H2), but the present disclosure is not limited thereto. Because the height H1 is greater than the height H3, at least a portion of the conductive glue CA may be in contact with the first conductive layer CL, such that the conductive glue CA may be electrically connected to the first conductive layer CL. In addition, because the height H1 is less than or equal to 0.2 times of the height H2, the conductive glue CA can still be electrically connected to the first conductive layer CL while reducing the amount of conductive glue CA. It should be noted that when the second substrate SB2 is substantially aligned with the first conductive layer CL in the direction Z, the height H1 of the upper part of the conductive glue CA may be defined as the vertical distance between the top surface S1 of the second substrate SB2 and the top surface S2 of the conductive glue CA or the maximum height of the conductive glue CA from the top surface S1 of the second substrate SB2 to the top surface S2 of the conductive glue CA, but not limited thereto.

As mentioned above, in addition to be electrically connected to the first conductive layer CL, the conductive glue CA may further be electrically connected to the metal pad MP disposed on the first substrate SB1 in the present embodiment, such that the first conductive layer CL may be electrically connected to the metal pad MP. According to the present embodiment, the width of the conductive glue CA may be within a certain range, such that it can be electrically connected to the metal pad MP. In detail, as shown in the cross-sectional view of FIG. 1, the maximum width of the metal pad MP from the outermost sidewall of the sealing element SE which is close to the metal pad MP to the edge of the metal pad MP in the direction X may for example be the second width W2, and the conductive glue CA may have the third width W3 at the top surface S3 of the metal pad MP, but not limited thereto. According to the present embodiment, the third width W3 may be greater than or equal to 0.5 times of the second width W2 and less than or equal to the second width W2 (that is, 0.5W2≤W3≤W2), but not limited thereto. When the third width W3 is greater than or equal to 0.5 times of the second width W2, because the conductive glue CA occupies at least half of the width of the metal pad MP, poor contact between the conductive glue CA and the metal pad MP may be reduced. When the third width W3 is equal to the second width W2, the conductive glue CA may roughly cover the metal pad MP, so the third width W3 may be designed to be less than or equal to the second width W2 to reduce the poor contact between the conductive glue CA and the metal pad MP while reducing the amount of the conductive glue CA, thereby reducing the production cost, but not limited thereto. In some embodiments, the relationship between the third width W3 and the second width W2 may be decided according to the demands of the design. It should be noted that although the third width W3 is defined as the width of the conductive glue CA at the top surface S3 of the metal pad MP, the present disclosure is not limited thereto. The comparison of the third width W3 and the second width W2 mentioned above is based on the condition that the third width W3 and the second width W2 are located in the same side in a cross-sectional view, such as the right side of FIG. 1, but not limited thereto. As long as the widths and distances for comparison are located at the same side of the display device, other sides of the display device may optionally be selected for comparison. In some embodiments, the widths of other planes of the conductive glue CA perpendicular to the direction Z may be regarded as the third width W3 according to the demands of the design, but not limited thereto. According to the present embodiment, because the first conductive layer CL is electrically connected to the metal pad MP through the conductive glue CA, the static electricity on the surface of the glass (such as the glass substrate of the second substrate SB2, but not limited thereto) may be discharged or partially discharged through the first conductive layer CL, the conductive glue CA and the metal pad MP to reduce the defects of bright spots of the displayed images of the display device DD. In detail, when the electrostatic charges are generated on the surface of the glass of a conventional display device, the action of the liquid crystal molecules of the display medium layer LC may be affected, such that the direction of the liquid crystal molecules may be changed, and bright spots or dark spots may occur on the displayed images. In the present disclosure, the first polarizer PL1 of the display device DD includes the first conductive layer CL electrically connected to the metal pad MP, wherein the metal pad MP may for example be connected to a common electrode and have a common voltage. Therefore, the first conductive layer CL connected to the metal pad MP and the metal pad MP may for example have the same common voltage to reduce the voltage difference between them, such that the defects of the bright spots caused by the direction change of liquid crystal molecules due to the extra voltage difference caused by the static electricity may be reduced, but the present disclosure is not limited thereto. In some embodiments, the metal pad MP electrically connected to the first conductive layer CL may be manufactured in the same layer as any other suitable electronic elements or layers on the first substrate SB1 according to different demands of design as long as the voltage difference between the upper side and the lower side of liquid crystal molecules due to the static electricity on the glass substrate can be avoided or the voltage difference between them can be reduced, the present disclosure is not limited thereto.

It should be noted that the shape of the conductive glue CA disposed on the metal pad MP is not limited to what is shown in FIG. 1 in the present disclosure. In detail, as shown in FIG. 1, the outer surface of the conductive glue CA and the metal pad MP may have an included angle θ, wherein the included angle θ may be the included angle between the tangent of the contact position of the outer surface of the conductive adhesive CA and the metal pad MP and the top surface S3 of the metal pad MP, and the outer surface of the conductive glue CA may be the surface away from the side surface E1 and the side surface E2, but not limited thereto. According to the present embodiment, as shown in FIG. 1, the included angle θ may for example be an acute angle, or, the lower part of the conductive glue CA may protrude from the upper part of the conductive glue CA, but not limited thereto. In some embodiments, the included angle θ may be an obtuse angle because the amount and the curing time of the conductive glue CA may be different, but not limited thereto. The contents about the shape of the conductive glue CA mentioned above may be applied to each of the embodiments of the present disclosure, and will not be redundantly described in the following.

The display device DD of the present disclosure may optionally include an optical material layer OP, a cover layer CO, a backlight module BL and a shell OS in addition to the above-mentioned elements or layers. The optical material layer OP is disposed on the first polarizer PL1, or in other words, the optical material layer OP is disposed between the first polarizer PL1 and the cover layer CO. The optical material layer OP may for example include optical transparent glue, other similar materials or the combinations of the above-mentioned materials, but not limited thereto. The cover layer CO is disposed on the optical material layer OP, and the cover layer CO may for example include glass or other materials covering other elements or layers of the display device DD to protect them, but not limited thereto. The backlight module BL is disposed under the second polarizer PL2, and the backlight module BL may for example include a light source, a light guiding plate, a diffuser (not shown in FIG. 1), a brightness enhancement film, a reflector and the like, but not limited thereto. The shell OS may be connected to the backlight module BL, and may be connected to the cover layer CO of the display device DD. In the present embodiment, the backlight module BL, the display panel DP, the first polarizer PL1 and the second polarizer PL2 are disposed in the shell OS, but not limited thereto. The shell OS may for example include the metal materials or the plastic materials which are suitable to serve as the shell of the device, but not limited thereto. It should be noted that the elements or the layers of the display device DD shown in FIG. 1 are only exemplary, and they do not represent all of the elements or the layers included in the display device DD. In some embodiments, the display device DD may include other suitable elements or layers according to the demands of the design, the present disclosure is not limited thereto.

As mentioned above, the first polarizer PL1 of the display device DD includes the first conductive layer CL in the present disclosure, wherein the first conductive layer CL may be electrically connected to the metal pad MP disposed on the first substrate SB1 through the conductive glue CA, so as to discharge or partially discharge the static electricity on the surface of the glass through the first conductive layer CL, the conductive glue CA and the metal pad MP, thereby reducing the possibility of the bright spots occurring on the displayed images of the display device DD due to the direction change of liquid crystal molecules caused by the static electricity. Other embodiments of the present disclosure will be described in the following. It should be note that the materials and the disposition methods of each of the elements and the layers (such as the second substrate SB2, the display medium layer LC, the sealing element SE, the circuit layer Ml and the first substrate SB1, but not limited thereto) of the display panel DP of the first embodiment, the optical material layer OP and the cover layer CO mentioned above may be applied to each of the embodiments in the following, and will not be redundantly described.

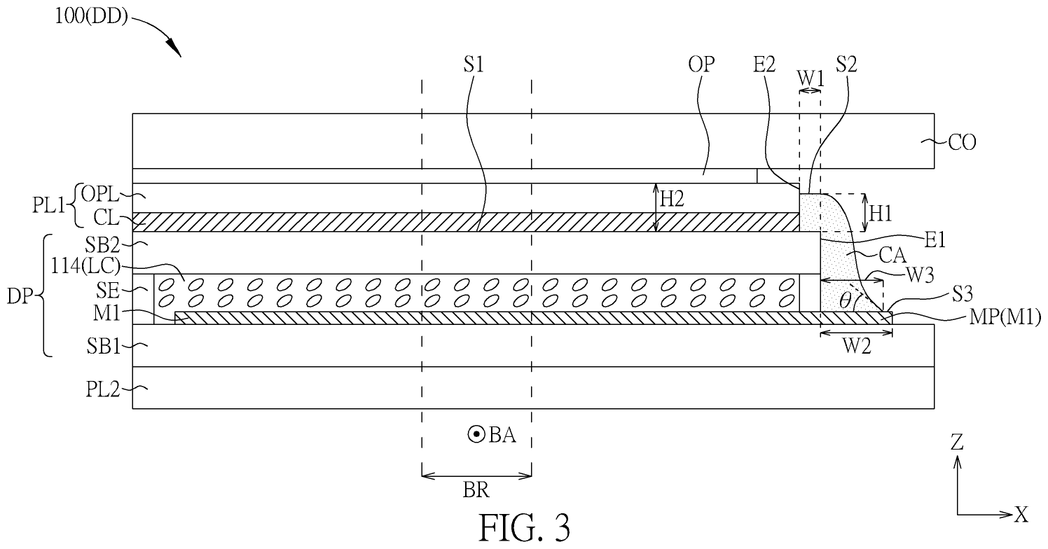

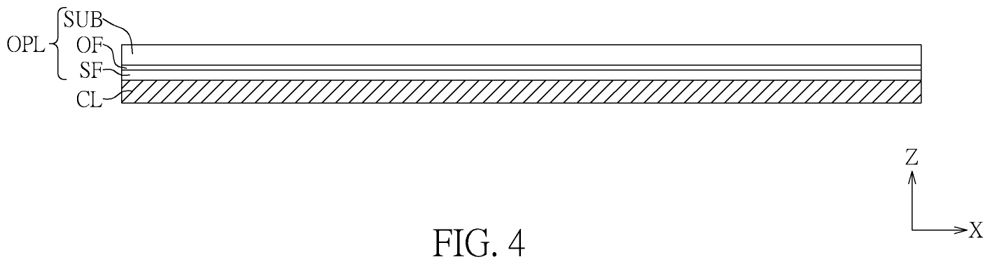

Referring to FIG. 3 and FIG. 4, FIG. 3 schematically illustrates a cross-sectional view of an electronic device according to a second embodiment of the present disclosure, and FIG. 4 schematically illustrates a cross-sectional view of a polarizer according to the second embodiment of the present disclosure. In order to simplify the figure, the backlight module and the shell are omitted in FIG. 3. In addition, although FIG. 3 does not show the bending axis and the bending region, the display device DD of the present embodiment may for example be a flexible display device, the present disclosure is not limited thereto. One of the differences between the second embodiment and the first embodiment is the design of the first polarizer (or the second polarizer) of the display device. As shown in FIG. 3 and FIG. 4, the first polarizer PL1 of the present embodiment may for example include the first optical layer OPL and the first conductive layer CL, but not limited thereto. The first optical layer OPL may for example include the supporting base SUB, the optical film OF and the compensation film SF, but not limited thereto. The materials and disposition ways of these layers may refer to the above-mentioned first embodiment, and will not be redundantly described. According to the present embodiment, the first conductive layer CL may be adhesive, or in other words, the first conductive layer CL may for example be a conductive glue in the present embodiment, but not limited thereto. Because the first conductive layer CL of the present embodiment is adhesive, the first polarizer PL1 may be adhered to the second substrate SB2 through the first conductive layer CL. That is, the display device DD of the present embodiment may not include the glue GL shown in FIG. 1, and the first conductive layer CL may be in contact with the second substrate SB2, but not limited thereto. Other elements or layers shown in FIG. 3 may be referred to in the first embodiment mentioned above, and will not be redundantly described here. It should be noted that in the contents about the height of the conductive glue CA in the above-mentioned first embodiment, the sum of the height of the first polarizer PL1 (including the first optical layer OPL and the first conducive layer CL) and the height of the glue GL is defined as the height H2 in order to illustrate the height range of the conductive glue CA, however, because the display device DD does not include the glue layer in the present embodiment, the height H2 may be defined as the height of the first polarizer PL1 (that is the sum of the height of the first optical layer OPL and the height of the first conductive layer CL), and the height H3 of the glue shown in FIG. 1 is not included in the present embodiment, but not limited thereto. Therefore, because the first conductive layer CL is located on the second substrate SB2 and directly in contact with the second substrate SB2 in the present embodiment, the conductive glue CA may be in contact with the first conductive layer CL and electrically connected to the first conductive layer CL when the height H1 of the conductive glue CA located on the top surface S1 of the second substrate SB2 is greater than 0. Therefore, the height H1 may for example be greater than 0 and less than or equal to 0.2 times of the height H2 (that is, 0<H1≤0.2H2) in the present embodiment. The definitions of the height H1, the second width W2 and the third width W3, and the relationship between the second width W2 and the third width W3 may be referred to in the first embodiment mentioned-above, and will not be redundantly described.

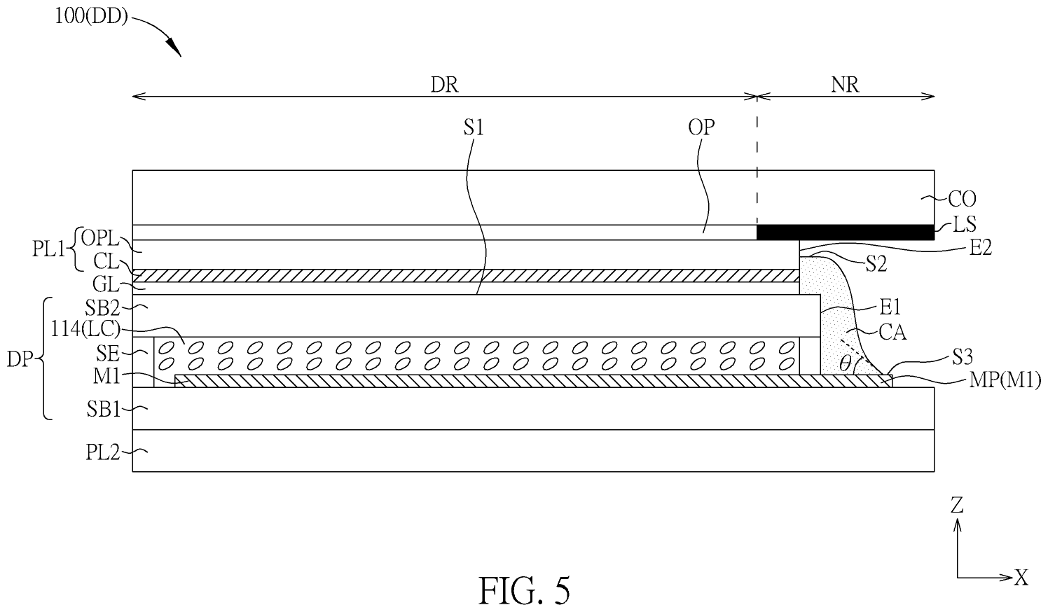

Referring to FIG. 5, FIG. 5 schematically illustrates a cross-sectional view of an electronic device according to a third embodiment of the present disclosure. In order to simplify the figure, the backlight module and the shell are omitted in FIG. 5. One of the differences between the third embodiment and the first embodiment is the design of the display device. As shown in FIG. 5, the display device DD may include a light shielding layer LS in the present embodiment, wherein the light shielding layer LS is disposed on the surface of the cover layer CO. In detail, the optical material layer OP and the light shielding layer LS may be disposed on the bottom surface of the cover layer CO, wherein the optical material layer OP may for example be disposed in the display region DR of the display device DD, and the light shielding layer LS may for example be disposed in the non-display region NR of the display device DD, but not limited thereto. The material of the light shielding layer LS may for example include ink, other suitable light shielding materials or the combinations of the above-mentioned materials, but not limited thereto. According to the present embodiment, the light shielding layer LS may be overlapped with the conductive glue CA in a top view, for example, the conductive glue CA may be shielded by the light shielding layer LS. In detail, as shown in FIG. 5, the light shielding layer LS may be overlapped with the conductive glue CA in the direction Z, or in other words, the light shielding layer LS may cover the conductive glue CA in the direction Z. Because the conductive glue CA may be an opaque conductive glue in the present disclosure, the light shielding layer LS may be disposed above the conductive glue CA, such that the conductive glue CA is invisible to the users. It should be noted that although the edge of the light shielding layer LS is substantially aligned with the edge of the cover layer CO, the present disclosure is not limited thereto. In some embodiments, the light shielding layer LS may have any suitable shape or length as long as it can be overlapped with the conductive glue CA and cover the conductive glue CA. The material and disposition way of the light shielding layer LS of the present embodiment may be optionally applied to the first embodiment, the second embodiment mentioned above and each of the following embodiments, and will not be redundantly described.

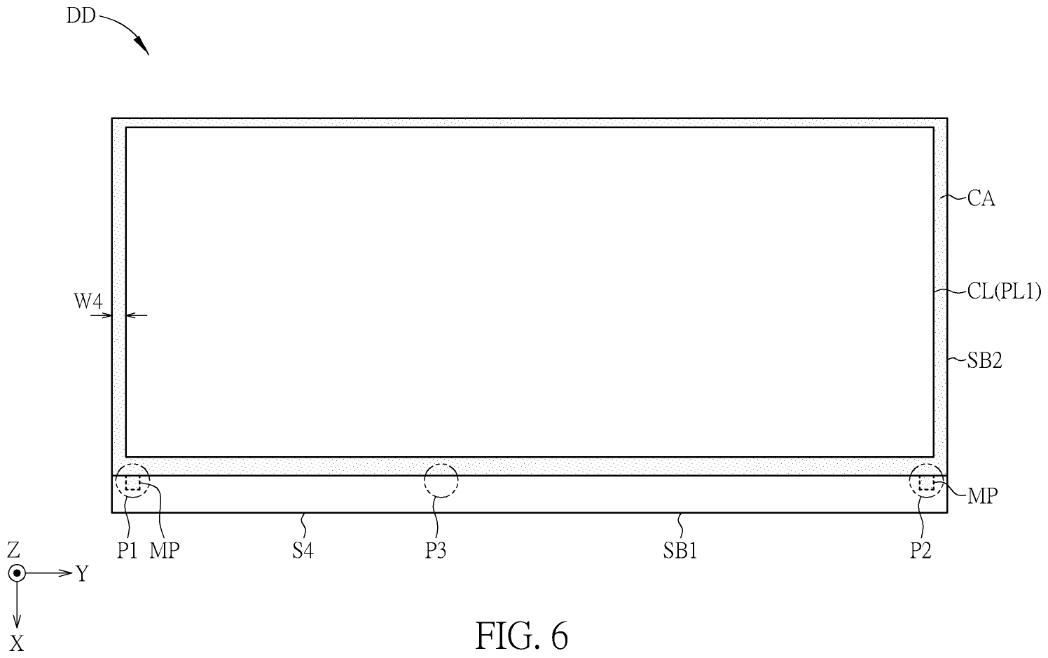

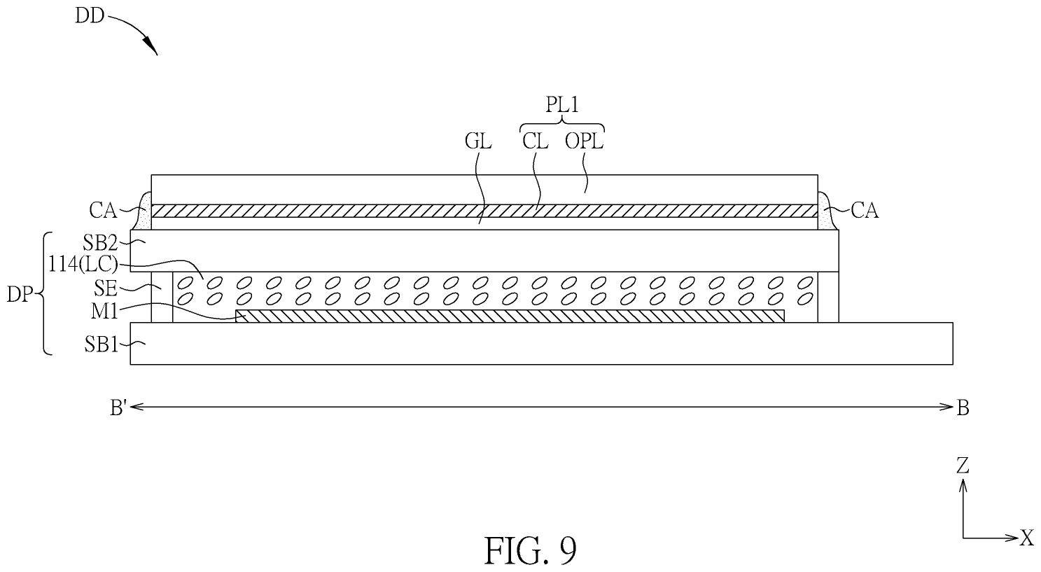

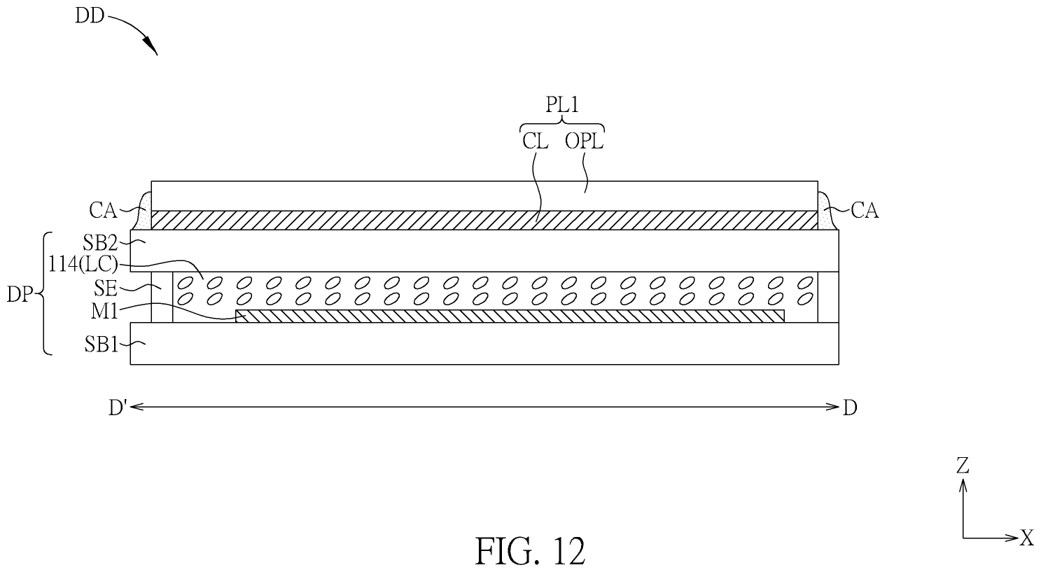

Referring to FIG. 6, FIG. 6 schematically illustrates a top view of an electronic device according to an embodiment of the present disclosure. FIG. 6 shows the disposition condition of the conductive glue CA relative to the first polarizer PL1, the first substrate SB1 and the second substrate SB2 according to an embodiment. According to the present embodiment, the conductive glue CA may be disposed along four sides of the second substrate SB2, wherein the four sides of the second substrate SB2 may respectively protrude from four sides of the first polarizer PL1 in order to dispose the conductive glue CA on the second substrate SB2. For example, the distance (such as the fourth distance W4) between each side of the second substrate SB2 and the corresponding side of the first polarizer PL1 near that side may range from 0.2 millimeters (mm) to 0.3 mm, but not limited thereto. In detail, as shown in FIG. 6, the first polarizer PL1 may include four sides, or in other words, the first conductive layer CL of the first polarizer PL1 may include four sides, wherein the conductive glue CA may be disposed on the second substrate SB2 along the four sides of the first conductive layer CL, and the conductive glue CA may at least be in contact with the first conductive layer CL, but not limited thereto. In some embodiments, the distance (such as the fourth distance W4) between the side of the second substrate SB2 and the corresponding side of the first polarizer PL1 near that side may for example be the same or different in each of the sides of the second substrate SB2. The first polarizer PL1 of the present embodiment may adopt the first polarizer of the first embodiment or the first polarizer of the second embodiment, and the height of the conductive glue CA meeting the demands that the conductive glue CA is at least in contact with the first conductive layer CL may be referred to in the first embodiment or the second embodiment mentioned above according to the type of the first polarizer adopted, and will not be redundantly described here. In the present embodiment, the first substrate SB1 may include at least one metal pad MP, for example, as shown in FIG. 6, the first substrate SB1 may include two metal pads MP, but not limited thereto. Because the first conductive layer CL may be electrically connected to the metal pads MP on the first substrate SB1 through the conductive glue CA in the present disclosure, the conductive glue CA corresponding to the position of the metal pads MP (or the conductive glue CA close to the position of the metal pads MP, but not limited thereto) may extend and protrude from the second substrate SB2 to be disposed on the metal pads MP, so as to be electrically connected to the metal pads MP. For example, as shown in FIG. 6, because the region P1 and the region P2 of the first substrate SB1 include the metal pad MP, the conductive glue CA corresponding to the regions (region P1 and region P2) may protrude from the second substrate SB2 (for example, protrude toward the direction X) and be disposed on the metal pads MP, but not limited thereto. When the conductive glue CA is disposed on the metal pad MP and covers the metal pad MP, the cross-sectional view (along the direction X) of the structure may for example refer to FIG. 1 or FIG. 3. In another aspect, the conductive glue CA corresponding to the position of the first substrate SB1 on which the metal pad is not disposed may be disposed on the second substrate SB2 only, and the conductive glue CA may not extend and be disposed on the metal pad MP (for example, as shown in the region P3). Therefore, the first substrate SB1 may not include the conductive glue CA, and the cross-sectional view of the structure may for example refer to FIG. 9 or FIG. 12, but not limited thereto. In detail, because the first substrate SB1 in the region P3 does not include the metal pad MP, the conductive glue CA may not be disposed on the first substrate SB1 to reduce the amount of the conductive glue CA. In addition, according to the present embodiment, the metal pad MP may for example be located at a side of the first substrate SB1 protruding from the second substrate SB2. For example, as shown in FIG. 6, the two metal pads MP may be located at the side S4 of the first substrate SB1, but not limited thereto. When a side of the first substrate SB1 includes the metal pad MP, a certain distance may be included between the side of the first substrate SB1 and the second substrate SB2 to dispose the metal pad MP and the conductive glue CA, and when a side of the first substrate SB1 does not include the metal pad MP, the side of the first substrate SB1 may be substantially aligned with the second substrate SB2 in the direction Z. For example, as shown in FIG. 6, the side S4 of the first substrate SB1 may protrude from the second substrate SB2, and other three sides of the first substrate SB1 may be substantially aligned with the second substrate SB2 in the direction Z, but not limited thereto. In some embodiments, the metal pads MP may be disposed corresponding to more sides of the first substrate SB1, and the size of the first substrate SB1 may be adjusted according to the disposition position of the metal pads MP, or in some embodiments, the side of the first substrate SB1 not including the metal pad MP may not be aligned with the second substrate SB2 in the direction Z, the present disclosure is not limited thereto. In the present embodiment, because the conductive glue CA may be disposed along four sides of the second substrate SB2, the contact area of the conductive glue CA and the first conductive layer CL electrically connected to each other may be increased. Therefore, the static electricity on the surface of the glass may be discharged or partially discharged by increasing the contact area of the conductive glue CA and the first conductive layer CL electrically connected to each other, such that the bright spots on the displayed images may be reduced, and the display quality of the display device may be improved. It should be noted that the disposition way of the conductive glue CA of the present embodiment may be applied to each of the embodiments of the present disclosure, and will not be redundantly described.

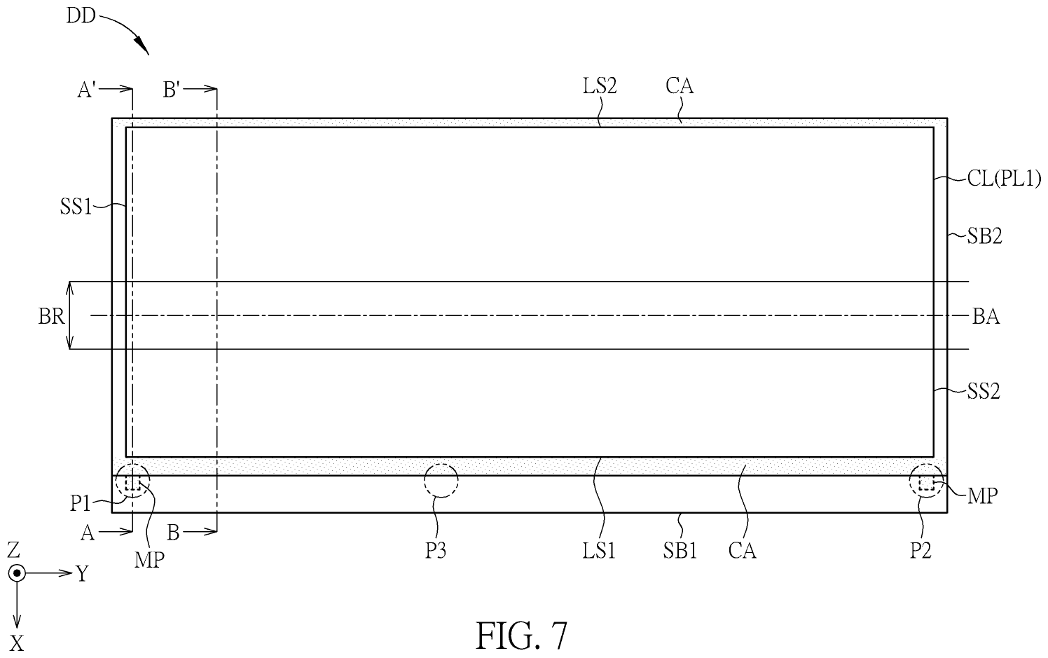

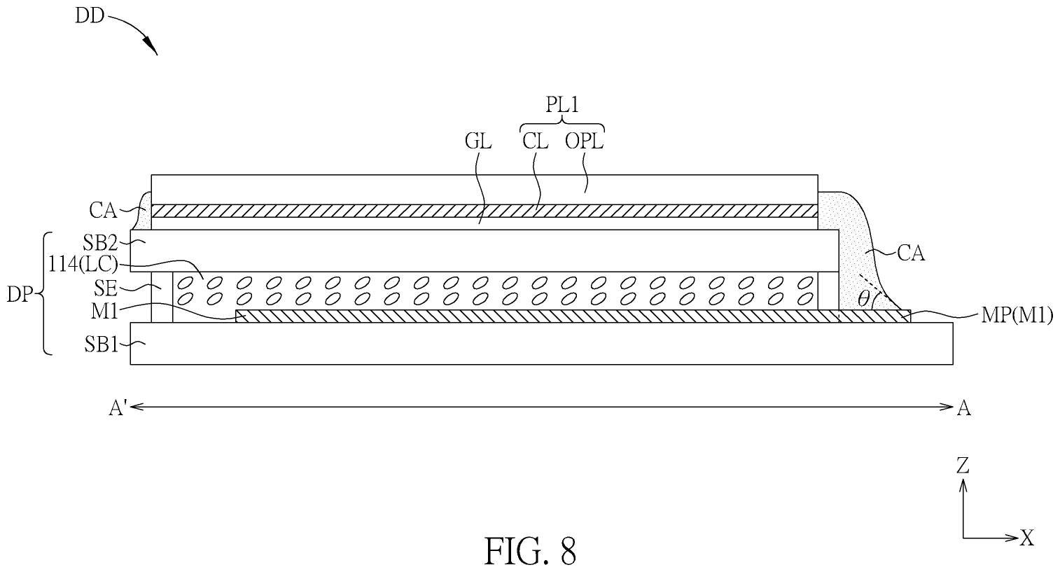

Referring to FIG. 7 to FIG. 9, FIG. 7 schematically illustrates a top view of an electronic device according to a fourth embodiment of the present disclosure, FIG. 8 schematically illustrates a cross-sectional view taken along a line A-A′ shown in FIG. 7, and FIG. 9 schematically illustrates a cross-sectional view taken along a line B-B′ shown in FIG. 7. According to the present embodiment, because the display device DD of the present disclosure may for example be a flexible display device, the display device DD may have at least one bending axis BA, and the display device DD may at least be curved, folded, stretched, flexed, rolled or deformed in other ways along the at least one bending axis BA, but not limited thereto. For example, as shown in FIG. 7, the display device DD of the present disclosure may for example include a bending axis BA located on the short side SS1 (or the short side SS2) of the first conductive layer CL, and the region of the display device DD close to the bending axis BA may be defined as the bending region BR, wherein the portion of the display device DD in the bending region BR of the display device DD may be curved, folded, stretched, flexed, rolled or deformed in other ways, but not limited thereto. It should be noted that although only a bending axis BA and a bending region BR are shown in FIG. 7, the present disclosure is not limited thereto. In some embodiments, the display device DD may include two or more bending axes BA, wherein the bending axes BA may be located on the short side SS1 and/or the short side SS2, and the bending axes may be parallel to each other or not, the present disclosure is not limited thereto. The “bending axis BA is located on the short side SS1” mentioned above may represent that the bending axis BA may be overlapped with the short side SS1 of the first conductive layer CL in the direction Z, that is, the extending direction of the bending axis BA would be crossed with the short side SS1 and the short side SS2 when it is being observed from the direction Z. As shown in FIG. 7, the bending axis BA of the present embodiment may be parallel to the long side LS1 (or the long side LS2) of the first conductive layer CL, but not limited thereto. In some embodiments, the bending axis BA may be disposed on the short side SS1 of the first conductive layer CL, and the bending axis BA may not be parallel to the long side LS1 of the first conductive layer CL, but not limited thereto. According to the present embodiment, because the bending axis BA of the display device DD is overlapped with the short side SS1 and the short side SS2, or in other words, the short side SS1 and the short side SS2 of the first conductive layer CL may be disposed in the bending region BR, the conductive glue CA may for example be disposed on the second substrate SB2 along the sides of the first polarizer PL1 (or the first conductive layer CL) corresponding to the long side LS1 and the long side LS2, or in other words, the conductive glue CA may be disposed on the second substrate SB2 without being overlapped with the bending axis BA, but not limited thereto. In other words, the first conductive layer CL of the present embodiment may for example include four sides (short side SS1, short side SS2, long side LS1, long side LS2), wherein two sides (such as the short side SS1 and the short side SS2 in the present embodiment) of the four sides may be disposed in the bending region BR, and the conductive glue CA may be disposed corresponding to the long side LS1 and the long side LS2, that is, the conductive glue CA may be disposed between the short side SS1 and the short side SS2 in the present embodiment, but not limited thereto. According to the present embodiment, because the conductive glue CA is not overlapped with the bending axis BA, or the conductive glue CA is not disposed in the bending region BR, the effect of the conductive glue CA on the flexibility of the display device DD may be reduced. In detail, because the conductive glue CA is not included in the bending region BR of the display device DD, when the display device is deformed, the conductive glue CA would not be deformed due to the deformation of the display device DD, and the possibility that the flexibility of the display device DD is affected by the properties of the conductive glue CA (such as the flexibility of the conductive glue CA) can be reduced, but not limited thereto.

Similarly, as mentioned above, the conductive glue CA of the present disclosure may electrically connect the first conductive layer CL of the first polarizer PL1 and the metal pad MP disposed on the first substrate SB1. Because the conductive glue CA is disposed corresponding to the long side LS1 and the long side LS2 in the present embodiment, the metal pad MP on the first substrate SB1 may for example be disposed corresponding to the long side LS1 and/or the long side LS2 of the first conductive layer CL in the present embodiment. For example, as shown in FIG. 7, the display device DD may include two metal pads MP in the present embodiment, wherein the metal pads MP may for example be disposed on the first substrate SB1 corresponding to the ling side LS1, but not limited thereto. The side of the first substrate SB1 (such as the side corresponding to the long side LS1 shown in FIG. 7) at which the metal pads MP are disposed may protrude from the second substrate SB2 in the direction Z. Because the conductive glue CA is electrically connected to the metal pads MP, the conductive glue CA corresponding to the disposition position of the metal pads MP may extend and be disposed on the metal pads MP (shown in the region P1 and the region P2 of FIG. 7), and the conductive glue CA not corresponding to the disposition position of the metal pads MP may be disposed on the second substrate SB2 (shown in the region P3), but not limited thereto. FIG. 8 schematically illustrates a cross-sectional view of the display device DD along the line A-A′ shown in FIG. 7, wherein the line A-A′ passes through the metal pad MP of the display device DD. FIG. 9 schematically illustrates a cross-sectional view of the display device DD along the line B-B′ shown in FIG. 7, wherein the line B-B′ does not pass through the metal pad MP of the display device DD. In order to simplify the figures, layers or elements such as the cover layer, the optical material layer, the second polarizer and the like of the display device DD are omitted in FIG. 8 and FIG. 9. As shown in FIG. 8, because a side of the display device DD (such as the right side, as shown in FIG. 8) includes the metal pad MP, the conductive glue CA (such as the conductive glue CA in the right side of FIG. 8) may extend and be disposed on the metal pad MP, and because another side of the display device DD (such as the left side, as shown in FIG. 8) does not include the metal pad MP, the conductive glue CA (such as the conductive glue CA in the left side of FIG. 8) may for example be disposed on the second substrate SB2, but not limited thereto. In some embodiments, the metal pads MP may for example be disposed corresponding to the long side LS1 and the long side LS2 of the first conductive layer CL in the same time, the two sides of the first substrate SB1 corresponding to the long side LS1 and the long side LS2 may protrude from the second substrate SB2 for disposition of the metal pads MP, and the conductive glue CA corresponding to the disposition position of the metal pads MP may extend and be disposed on the metal pads MP, but not limited thereto. In other embodiments, the metal pads MP may be disposed corresponding to the short side SS1 and/or the short side SS2, wherein the metal pads MP may be disposed corresponding to the two ends of the conductive glue CA to be electrically connected to the conductive glue CA, the sides of the first substrate SB1 corresponding to the short side SS1 and/or the short side SS2 may protrude from the second substrate SB2 due to the disposition of the metal pads MP, and the conductive glue CA corresponding to the disposition position of the metal pads MP may extend and be disposed on the metal pads MP, but not limited thereto. As shown in FIG. 9, because the line B-B′ does not pass through the metal pad MP, the conductive glue CA shown in FIG. 9 may be disposed on the second substrate SB2, but not limited thereto. It should be noted that although the first polarizer PL1 shown in FIG. 8 and the first polarizer PL1 shown in FIG. 9 are the first polarizer of the first embodiment, wherein the first polarizer includes the optical layer OPL and the first conductive layer CL, and the first polarizer PL1 is adhered to the second substrate SB2 by the glue GL, the present disclosure is not limited thereto. In some embodiments, the first polarizer PL1 of the display device DD may be the first polarizer of the second embodiment. The disposition ways of the conductive glue CA and the metal pads MP of the present embodiment may be applied to each of the embodiments of the present disclosure, and will not be redundantly described.

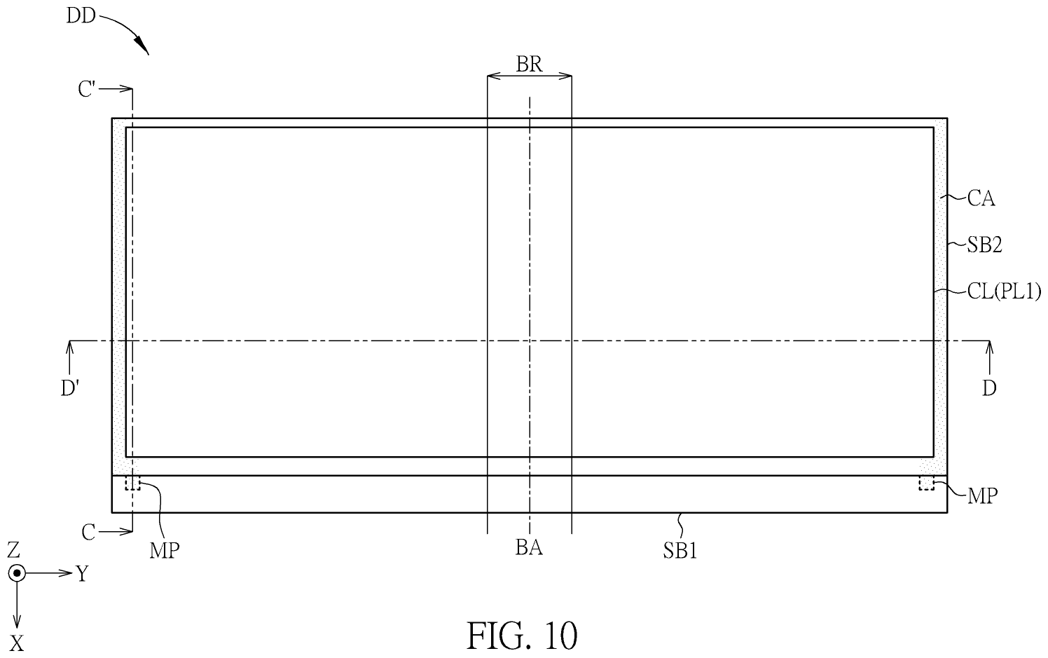

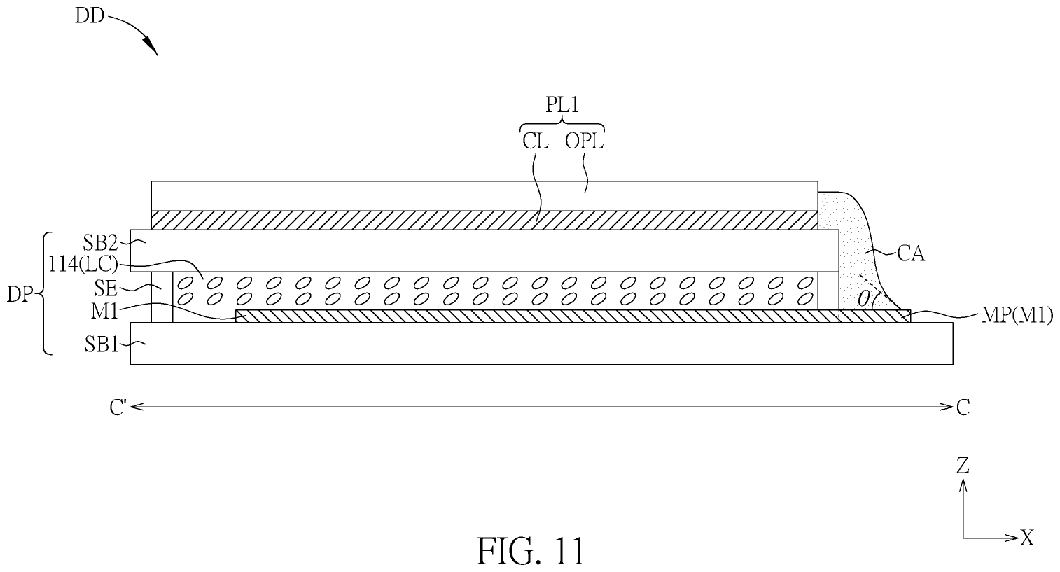

Referring to FIG. 10 to FIG. 12, FIG. 10 schematically illustrates a top view of an electronic device according to a fifth embodiment of the present disclosure, FIG. 11 schematically illustrates a cross-sectional view taken along a line C-C′ shown in FIG. 10, and FIG. 12 schematically illustrates a cross-sectional view taken along a line D-D′ shown in FIG. 10. One of the differences between the fifth embodiment and the fourth embodiment is the disposition position of the bending axis. As shown in FIG. 10, the bending axis BA of the present embodiment may for example be located on the long side LS1 (or the long side LS2) of the first conductive layer CL, that is, the extending direction of the bending axis BA may be crossed with the long side LS1 and the long side LS2 when it is being observed from the direction Z. In other words, the long side LS1 and the long side LS2 of the first conductive layer CL may be disposed in the bending region BR in the present embodiment. Similarly, although only a bending axis BA and a bending region BR are shown in FIG. 10, the present disclosure is not limited thereto. According to the present embodiment, because the bending axis BA of the display device DD is overlapped with the long side LS1 and the long side LS2, the conductive glue CA may for example be disposed on the second substrate SB2 along the sides of the first polarizer PL1 (or the first conductive layer CL) corresponding to the short side SS1 and the short side SS2, or in other words, the conductive glue CA may be disposed on the second substrate SB2 without overlapping the bending axis BA, but not limited thereto. Because the conductive glue CA is not overlapped with the bending axis BA, or the conductive glue CA may not be disposed in the bending region BR, the effect of the conductive glue CA on the flexibility of the display device DD may be reduced. In detail, because the conductive glue CA is not included in the bending region BR of the display device DD, when the display device is deformed, the conductive glue CA would not be deformed due to the deformation of the display device DD, and the possibility that the flexibility of the display device DD is affected by the properties of the conductive glue CA (such as the flexibility of the conductive glue CA) can be reduced, but not limited thereto.

As mentioned above, the conductive glue CA may electrically connect the first conductive layer CL and the metal pads MP in the present embodiment, wherein the side of the first substrate SB1 corresponding to the long side LS1 may protrude from the second substrate SB2 for disposition of the metal pads MP, as shown in FIG. 10. Because the conductive glue CA is disposed along the short side SS1 and the short side SS2 of the first conductive layer CL in the present embodiment, the metal pads MP may for example be disposed on the first substrate SB1 close to the ends of the conductive glue CA, such that the conductive glue CA may extend and be disposed on the metal pads MP conveniently to be electrically connected to the metal pads MP, as shown in FIG. 10, but not limited thereto. It should be noted that the positions of the metal pads MP on the first substrate SB1 are not entirely corresponding to the ends of the conductive glue CA, and in order to make the conductive glue CA capable of being electrically connected to the metal pads MP, a portion of the conductive glue CA may be disposed along the long sides of the first conductive layer, and the portion of the conductive glue CA may not be located in the bending region BR, but not limited thereto. That is, in some embodiments, the conductive glue CA may be disposed at any suitable position of the display device DD as long as the conductive glue CA is not overlapped with the bending axis BA in the direction Z or the conductive glue CA is not located in the bending region BR, the present disclosure is not limited thereto. Similarly, the disposition way of the metal pads MP of the present embodiment is not limited to what is shown in FIG. 10. In some embodiments, the metal pads MP may be disposed at any suitable position of the first substrate SB1 according to the demands of the design as long as the conductive glue CA can electrically connect the metal pads MP and the first conductive layer CL, the present disclosure is not limited thereto.

FIG. 11 and FIG. 12 respectively show a cross-sectional view of the display device shown in FIG. 10 along the line C-C′ and the line D-D′, wherein the line C-C′ passes through the metal pad MP located on the first substrate SB1, and the line D-D′ does not pass through the metal pad MP. As shown in FIG. 11, because a side of the display device DD (such as the right side, as shown in FIG. 11) includes the metal pad MP, the conductive glue CA (such as the conductive glue CA in the right side of FIG. 11) may extend and be disposed on the metal pad MP; because another side of the display device DD (such as the left side, as shown in FIG. 11) does not include the metal pad MP, and the conductive glue CA is not disposed at the position corresponding to the long side LS2 in the present embodiment (as shown in FIG. 10), the left side of the first substrate SB1 of the display device DD shown in FIG. 11 may not protrude from the second substrate SB2, and the conductive glue CA may not be disposed on the second substrate SB2, but not limited thereto. As shown in FIG. 12, because the line D-D′ does not pass through the metal pad MP, the conductive glue CA may be disposed on the second substrate SB2. In addition, because the metal pad MP is not disposed at the sides of the first substrate SB1 corresponding to the short side SS1 and the short side SS2 in the present embodiment, the left side and the right side of the first substrate SB1 are not protrude from the second substrate SB2, as shown in FIG. 12, but not limited thereto. It should be noted that although the first polarizer PL1 shown in FIG. 11 and the first polarizer PL1 shown in FIG. 12 are the first polarizer of the second embodiment, wherein the first polarizer includes the optical layer OPL and the adhesive first conductive layer CL, the present disclosure is not limited thereto. In some embodiments, the first polarizer PL1 of the display device DD may adopt the first polarizer of the first embodiment. The disposition ways of the conductive glue CA and the metal pads MP of the present embodiment may be applied to each of the embodiments of the present disclosure, and will not be redundantly described.

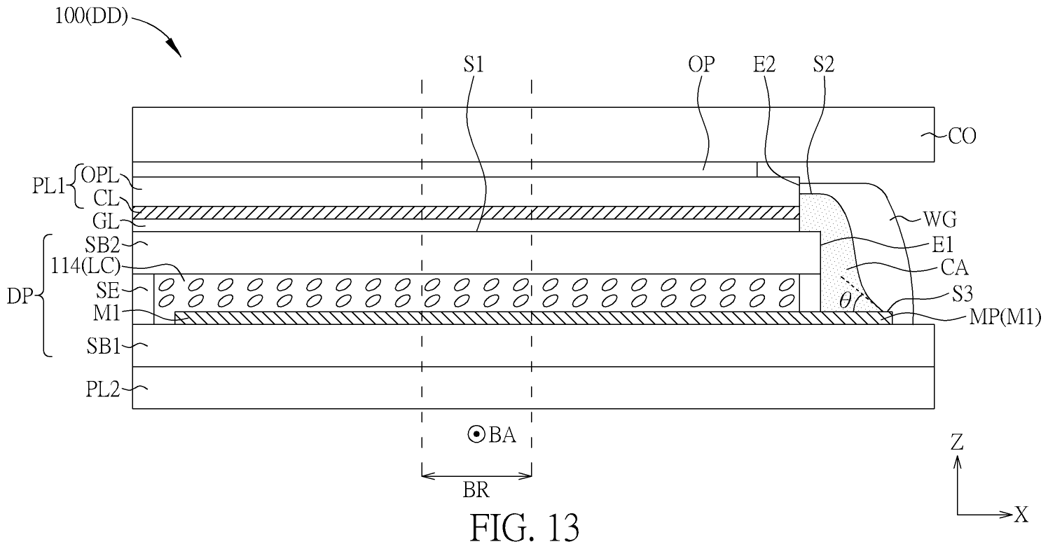

Referring to FIG. 13, FIG. 13 schematically illustrates a cross-sectional view of an electronic device according to an embodiment of the present disclosure. One of the differences between the present embodiment and the first embodiment is the design of the display device. As shown in FIG. 13, the display device DD of the present embodiment may further include a waterproof glue WG, wherein the waterproof glue WG may for example include tuffy glue, other suitable waterproof glue materials or the combinations of the above-mentioned materials, but not limited thereto. According to the present embodiment, the waterproof glue WG may for example be disposed on the first substrate SB1 and the conductive glue CA, wherein the waterproof glue WG may cover the conductive glue CA. Because the conductive glue CA may be covered by the waterproof glue WG, and the waterproof glue WG may for example block the moisture or the oxygen from the outside, the possibility of deterioration of the conductive glue CA due to the contact between the conductive glue CA and the moisture or the oxygen may be reduced, and the electrical connection between the first conductive layer CL and the metal pad MP can be improved, but not limited thereto. It should be noted that although the first polarizer PL1 shown in FIG. 13 is the first polarizer of the first embodiment, the present disclosure is not limited thereto. In some embodiments, the first polarizer PL1 of the display device DD may be the first polarizer of the second embodiment. In addition, the disposition of the waterproof glue WG mentioned in the present embodiment may be applied to the above-mentioned embodiments.

In summary, a display device is provided by the present, wherein the polarizer of the display device includes a conductive layer. In addition, the substrate of the display device may include at least one metal pad, wherein the conductive layer of the polarizer may be electrically connected to the metal pads through the conductive glue of the display device. The static electricity on the surface of the glass of the display device can be discharged or partially discharged to reduce the effect of the static electricity on liquid crystal molecules by the conductive layer and the metal pad electrically connected to each other, such that the bright spots on the displayed images can be reduced, and the display quality of the display device can be improved.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A flexible display device having a bending region, comprising:
a display panel;
a first polarizer disposed on the display panel and including a first conductive layer and a first optical layer; and
a second polarizer disposed under the display panel,
wherein the first conductive layer is disposed between the first optical layer and the display panel.

2. The flexible display device according to claim 1, further comprising a first glue, wherein the first conductive layer is adhered to the display panel by the first glue.

3. The flexible display device according to claim 1, wherein the display panel comprises a liquid crystal display panel.

4. The flexible display device according to claim 1, wherein the first optical layer comprises an optical film, a compensation film and a supporting base.

5. The flexible display device according to claim 1, wherein the first conductive layer comprises indium tin oxide or indium zinc oxide.

6. The flexible display device according to claim 1, wherein the first conductive layer is adhesive.

7. The flexible display device according to claim 1, further comprising a conductive glue, wherein the display panel comprises a substrate and a metal pad disposed on the substrate, and the conductive glue is electrically connected with the first conductive layer and the metal pad.

8. The flexible display device according to claim 7, wherein the conductive glue comprises silver glue.

9. The flexible display device according to claim 7, wherein the display panel further comprises another substrate and a display medium layer disposed between the substrate and the another substrate, and a distance between a side surface of the first polarizer and a side surface of the another substrate ranges from 0 to 0.5 micrometers.

10. The flexible display device according to claim 9, wherein the display medium layer comprises liquid crystal.

11. The flexible display device according to claim 7, further comprising a waterproof glue, wherein the waterproof glue is disposed on the conductive glue and covers the conductive glue.

12. The flexible display device according to claim 11, wherein the waterproof glue comprises tuffy glue.

13. The flexible display device according to claim 7, wherein the first conductive layer has four sides, and the conductive glue is adhered to the first conductive layer along the four sides.

14. The flexible display device according to claim 7, wherein the first conductive layer has four sides, two of the four sides are disposed in the bending region, and the conductive glue is disposed between the two of the four sides.

15. The flexible display device according to claim 7, further comprising a covering layer and a light shielding layer disposed on a surface of the covering layer, wherein the conductive glue overlaps the light shielding layer in a top view direction of the flexible display device.

16. The flexible display device according to claim 15, wherein the light shielding layer comprises ink.

17. The flexible display device according to claim 7, wherein the first conductive layer has four sides, two of the four sides are disposed in the bending region, and the conductive glue is disposed between the other two sides of the four sides.

18. The flexible display device according to claim 7, wherein the metal pad has a second width, the conductive glue has a third width at a top surface of the metal pad, and the third width is greater than or equal to 0.5 times of the second width and less than or equal to the second width.

19. The flexible display device according to claim 1, further comprising:
an optical material layer disposed on the first polarizer;
a cover layer disposed on the optical material layer;
a backlight module disposed under the second polarizer; and
a shell connected to the backlight module.

20. The flexible display device according to claim 19, wherein the backlight module, the display panel, the first polarizer and the second polarizer are disposed in the shell.
